(19) United States
(12) Patent Application Publication
(10) Pub. No.: US 2016/0157142 A1
(43) Pub. Date: Jun. 2, 2016

(54) LTE DISCOVERY AFTER SYSTEM CHANGE

(71) Applicant: NOKIA TECHNOLOGIES OY, Espoo (FI)

(72) Inventors: Jussi-Pekka Koskinen, Oulu (FI); Hannu Bergius, Kangasala (FI); Jorma Kaikkonen, Oulu (FI)

(21) Appl. No.: 14/901,408

(22) PCT Filed: Jul. 3, 2013
(86) PCT No.: PCT/IB2013/055457

§ 371 Date: Dec. 28, 2015

(51) Int. Cl. H04W 36/00

(52) U.S. Cl. CPC H04W 36/0066; H04W 36/0022

(57) ABSTRACT

A user equipment is initially camped on an LTE/E-UTRAN cell (205). An eNodeB informs (210) the UE to return after circuit-switched fall-back, CSFB, and optionally provides re-direction/re-selection information. The UE then performs a CSFB (215) with a NodeB of a legacy network cell, such as GERAN/UTRAN/CDMA2000 cell. Upon release of the CSFB connection (220), the UE uses (230) the received re-direction information to identify a best cell candidate in LTE, and select back (235) to the LTE/E-UTRAN carrier.

### TECHNICAL FIELD

The teachings in accordance with the exemplary embodiments of this invention relate generally to LTE and legacy RATs (e.g. UTRAN, GERAN, etc.) and, more specifically, relate to a re-selection and/or selection ability of user equipment (UE) in a context of a system change.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
ACK acknowledgement
CS circuit switched
CSFB circuit switched fallback
eNB evolved NodeB
E-UTRAN evolved universal terrestrial radio access network
GPS global positioning system
IMS ip-multimedia subsystem
ISR idle mode Signaling Reduction
LTE long term evolution
MME mobility management entity
MO Mobile Originated
MT mobile Terminated
NAS non access stratum
NW network
PDP context packet data protocol context
PDCP packet data convergence protocol
PLMN public land mobile network
PS packet switched
RLC radio link control
RRC radio resource control
SRB signaling radio bearer
SRVCC single radio voice call continuity
TAU tracking area update
UE user equipment

In a circuit switched fallback (CSFB), for example, user equipment (UE) moves from an LTE network to a legacy radio access technology (RAT) network (e.g., GERAN or UTRAN) such as for circuit switched (CS) voice service. After the CS service has ended or is interrupted it may be best for both the end-user and system that the UE move back to LTE network as soon as possible.

A problem arises in that some legacy network deployments are not updated and therefore they do not support a re-selection or fallback to a source network such as an LTE or E-UTRAN network. This problem can be due to outdated software or hardware or both. Especially in cases where the hardware is outdated it might not allow the software to be updated. A result can be that LTE re-selection or selection related information or procedures for the UE to return to the LTE or E-UTRAN network could not introduced in the legacy network. Such issues can create long term problems for a UE which desires to reselect back to the LTE network for example. The Exemplary embodiments of the invention provide a novel solution to address at least these issues.

### SUMMARY

In an exemplary aspect of the invention, there is a method comprising: identifying, at a user equipment, that a system change from a currently associated network to a different network is needed; in response to the identifying, accessing information comprising system change information; and performing the system change to the different network based on the information.

In another exemplary aspect of the invention, there is an apparatus comprising: at least one processor; and at least one memory including computer program code, where the at least one memory and the computer program code are configured, with the at least one processor, to cause the apparatus to at least: identify, at a user equipment, that a system change from a currently associated network to a different network is needed; in response to the identifying, access information comprising system change information; and perform the system change to the different network based on the information.

In another exemplary aspect of the invention, there is an apparatus comprising: means for identifying that a system change from a currently associated network to a different network is needed; means, in response to the identifying, for accessing information comprising system change information; and means for performing the system change to the different network based on the information.

In accordance with the exemplary embodiments of the invention as described in the paragraph above the means for identifying, accessing, using, and performing comprises a non-transitory memory including computer program code, and the computer program code executed by at least one processor.

In another exemplary aspect of the invention, there is a method, comprising: sending by a network device towards a user equipment information informing the user equipment to perform a systems change to a different network; and sending by the network device towards the user equipment system change information to enable the user equipment to perform the system change autonomously.

In still another exemplary aspect of the invention, there is an apparatus comprising: at least one processor; and at least one memory including computer program code, where the at least one memory and the computer program code are configured, with the at least one processor, to cause the apparatus to at least: send towards a user equipment information informing the user equipment to perform a systems change to a different network; and send towards the user equipment system change information to enable the user equipment to perform the system change autonomously.

In yet another exemplary aspect of the invention, there is an apparatus, comprising: means for sending by a network device towards a user equipment information informing the user equipment to perform a systems change to a different network; and means for sending by the network device towards the user equipment system change information to enable the user equipment to perform the system change autonomously.

In accordance with the exemplary embodiments of the invention as described in the paragraph above the means for sending comprise a network interface, and a non-transitory memory including computer program code, and the computer program code executed by at least one processor.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 is a simplified block diagram of various devices suitable for use in practicing the exemplary embodiments of the invention;

FIG. 2 illustrates a communication flow chart of a method in accordance with the exemplary embodiments of the invention;

FIG. 3 illustrates a feature of a user equipment autonomously evaluating a best cell candidate using selection information in accordance with the exemplary embodiments of the invention; and

FIGS. 4A and 4B each illustrate a block diagram showing a method in accordance with the exemplary embodiments of the invention.

### DETAILED DESCRIPTION

As similarly stated above, in CSFB a UE moves from an LTE or E-UTRAN network to a legacy RAT network (e.g. GERAN or UTRAN network), such as for a CS voice service. After the CS service or call has ended it would be best for the end-user and system that the UE return to an LTE environment as soon as possible. However, a problem arises because many legacy NW deployments are not updated and therefore do not support such a return or selection by the UE. The exemplary embodiments of the invention address at least these issues and related shortfalls.

According to 3GPP TS 23.272 V11.4.0, once CS service ends in a CS domain, existing mechanisms can be used to move a UE to E-UTRAN. For example these existing mechanisms for mobility from GERAN/UTRAN/CDMA2000 to EUTRAN can include:
Support of measurements and cell re-selection procedure from UTRAN IDLE/CELL_PCH/URA_PCH and GERAN IDLE/PACKET_IDLE;
Support of RRC connection release or RRC connection reject with re-selection or selection procedure from UTRAN CELL_DCH/CELL_FACH/CELL_PCH/URA_PCH;
Support of CS connection release with re-selection or selection procedure from GERAN Dedicated/Dual Transfer Mode (IE “Cell selection indicator after release of all TCH and SDCCH;”
Support of measurements and reporting in connected mode; and
Support of handover procedure in connected mode.

It is noted that an RRCConnectionRelease type message for example can be used to command a release procedure of an RRC connection. The RRCConnectionRelease procedure can also be used with redirection information for CS fallback to GERAN or UTRAN. An RRCConnectionRelease procedure can be initiated by a source node, such as a legacy node, to release a connection of a UE towards an eNodeB. The RRCConnectionRelease message and related signaling may be used to move UE to other network nodes. The UE may use the signaling to initiate a Tracking Area Updating procedure to redirect to another network node, such as the MME. The RRCConnectionRelease message can include an information element or other message including an IdleModeMobilityControlInfo type message. This message can include a cell reselection priority for each frequency by means of separate lists for each RAT (including E-UTRA) possibly accessible by the UE. Such an information element or message associated with the RRCConnectionRelease message can also provide dedicated cell reselection priorities. If a UE has indicated that it has a “Voice domain preference for E-UTRAN” set to “CS voice only” or another preference such as “IMS PS Voice preferred, CS Voice as secondary for example, then the network is aware that the UE is to use CSFB to place all CS calls or possibly for only emergency calls, and the information takes this into account.

In accordance with the exemplary embodiments, during a procedure such as an attach procedure the network could preemptively provide a UE information for performing a system change to a different network (e.g., ReDirInf) prior the actual initiation of a CSFB procedure. Further, the exemplary embodiments of the invention utilize at least these features to enable a UE to autonomously return from a CSFB to a prior associated network or a different network. For example, the UE may change networks in an autonomous manner using measurements and evaluations such as provided that identify the candidate networks for a system change. Further, the UE may autonomously select the target for the system change based on rules/thresholds which may be provided by network. It is noted that the terms RRCConnectionRelease, IdleModeMobilityControlInfo, and ReDirInf are non-limiting and the operations associated with these terms such as described herein may be identified differently.

To apply these existing mechanisms for the mobility of the UE from GERAN/UTRAN/CDMA2000 to LTE, for example, updates to these legacy RAT networks are required. If these networks are not or cannot be updated to support the above these networks cannot operate to enable the UE to move from these legacy networks to LTE or E-UTRAN. It should be noted that although Rel-10 “fast return to LTE” (23.272 CR 0710) expects that a legacy system network (e.g. GERAN) is updated with the support features as stated above, the embodiments of the invention are intended to be used to the advantage of such networks which may not be wholly or otherwise updated.

For purposes of the discussion below it is noted that any use of only the term LTE or E-UTRAN is non-limiting. The exemplary embodiments of the invention can be used for either of these network types. Further, any use of the term re-selection, re-select, re-direction, re-direct, return, or fallback is non-limiting. The embodiments of the invention can be applied to any of these operations.

It is noted that in addition to the above, UE proprietary solutions exist where a UE would autonomously try to re-select back to an LTE layer after a prior CSFB without any assistance from the network. However, such proprietary solutions should clearly be avoided for at least the reason that different UEs would behave in different way. Thus, a standardized solution is preferred.

In accordance with an exemplary embodiment of the invention source or other system (e.g., LTE) signals including novel information are provided to a UE before or during CSFB information in order to enable and/or allow the UE to return (or to try to return) autonomously back to a source system after CSFB. As to distinguish this from the proprietary solutions mentioned above, these novel source signals and information can be utilized to the advantage of different UEs and different RAT systems, whereas such proprietary systems cannot. In accordance with the exemplary embodiments the UE would use the novel source signals and/or information to return to the source system where cell selection criteria, such that the cell being good enough for camping is fulfilled. This novel source system signaling could be realized with dedicated or broadcast signaling.

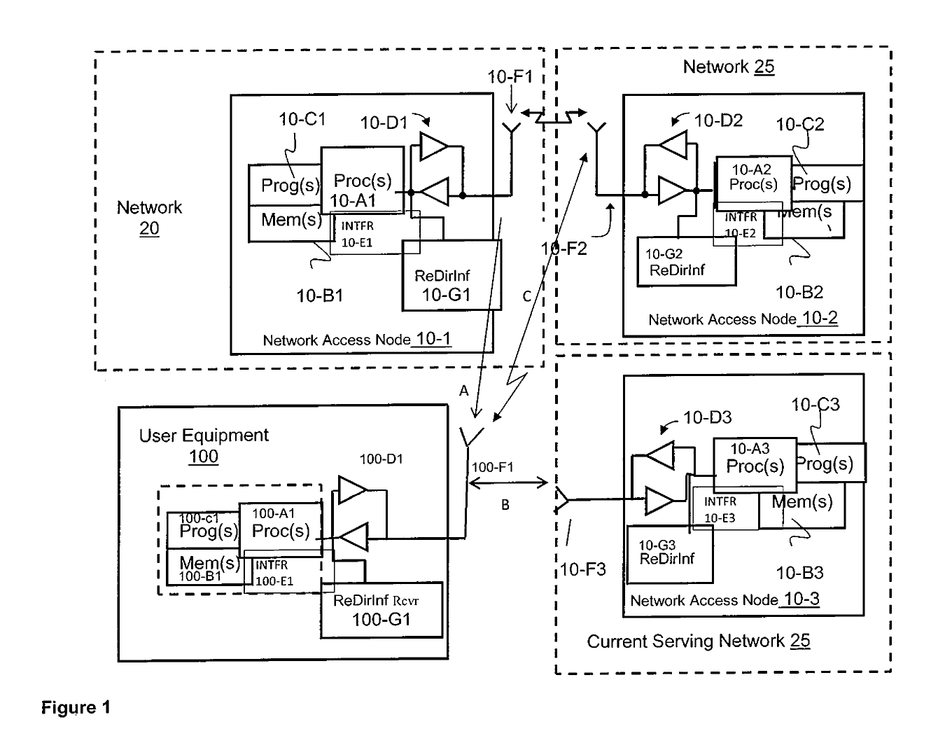

Before discussing the invention in detail reference will be made to FIG. 1. FIG. 1 illustrates an overview of one environment where the exemplary embodiments of the invention interference suppression may be practiced. FIG. 1 is a block diagram having a number of network access nodes 10 communicating in a network 20. The network 20 can include wireless/wired networks and more than one cell. In accordance with the exemplary embodiments of the invention, communications between devices, such as the devices in FIG. 1, can include direct communication, communication via another device that is of the network or outside the network and/or via the Internet. In addition, any part or all of these communications may be offloaded to a 3^{rd} party network or device. The network 20 includes network access nodes 10-1, 10-2, and 10-3, in wireless and/or wired communication. The network access node 10-1 includes one or more processors 10-A1, one or more memories 10-B1 containing one or more programs 10-C1, a radio frequency transceiver 10-D1 able to receive and transmit data, an interface 10-E1, and one or more antennas 10-F1. Similarly, the network access node 10-2 includes one or more processors 10-A2, one or more memories 10-B2 containing one or more programs 10-C2, a radio frequency transceiver 10-D2 able to receive and transmit data, an interface 10-E2, and one or more antennas 10-F2. In the example of FIG. 1, the network access node 10-3 includes one or more processors 10-A3, one or more memories 10-B3 containing one or more programs 10-C3, an interface 10-E3, and one or more antennas 10-F3. It is noted that any of the interfaces 10-E1, 10-E2, and 10-E3 can comprise at least one of or a combination of a wired and/or wireless interface. The wireless interface may be referred to as an air interface. In addition, any of these interfaces can be configured to provide a wired, wireless, and/or backhaul connection interface.

In addition, the network access nodes 10-1, 10-2, and 10-3 can each include a re-selection or selection information processor (ReDirInf) 10-G1, 10-G2 and 10-G3, respectively, to provide the source signaling and/or re-selection or selection information and enable the novel operations in accordance with the exemplary embodiments of the invention. For instance, the network access nodes 10-1, 10-2, and 10-3 could each be a base station which is/are transmitting and/or receiving information comprising the novel source signaling and/or re-selection or selection information.

The User Equipment 100 as in FIG. 1 includes one or more processors 100-A1, one or more memories 100-B1 containing one or more programs 100-C1, a radio frequency transceiver 100-D1 able to receive and transmit data, an interface 100-E1, and one or more antennas 100-F1. The interface 100-E1 is configured to operate as a wireless interface, also referred to as an air interface for communication with the network. Further, the User Equipment 100 also includes a re-selection or selection information processor receiver (ReDirInf) 100-G1. In accordance with the exemplary embodiments of the invention, the ReDirInf processor 100-G1 is configured to at least utilize the novel signaling information of the invention to allow the User Equipment 100 to autonomously perform re-selection or selection to a source or other network layer using the re-selection information. The User Equipment 100 can be any mobile equipment such as a cellular phone or other cellular device, and the network access node 10-1 could be a serving access node network of a cell where the User Equipment 100 is located. Further, as illustrated there may be a wired and/or wireless connections established between any of the network access nodes 10-1, 10-2, and 10-3. Any of these connections may be used for communications of novel signaling and information in accordance with the exemplary embodiments of the invention.

As shown in FIG. 1, there exist several interconnections between the network parts shown by corresponding arrows or lines. These interconnections may be established by means of interfaces or reference points which may be different in dependence of the employed network technology and which are known to those skilled in the art. In accordance with the exemplary embodiments signaling including the re-selection or selection information can be sent from a network node such as the Network Access Node 10-1. As illustrated with the signal line A the re-selection or selection information can be signaled to the User Equipment 100. In addition, in accordance with the embodiments the re-selection or selection information can be part of the system code of the User Equipment 100. Thus, the re-selection or selection information can be input to the User Equipment 100 anytime during and after manufacture of the User Equipment 100. Further, signaling from a network node such as the Network Access Node 10-1 can include a command to cause the User Equipment 100 to perform a re-selection or selection in accordance with the invention.

In accordance with the exemplary embodiments of the invention, the network access nodes 10-2, and 10-3 can transmit also signal re-selection or selection information over a dedicated channel. In addition, the re-selection or selection information may be broadcast. The network access node 10-1 can receive this re-selection or selection information and forward the information to the User Equipment 100 via its interface 10-E1. Similarly, in accordance with the exemplary embodiments, the User Equipment 100 can receive the re-selection or selection information via its interface 100-E over the one or more antennas 100-F1. The User Equipment 100 can use this information to identify a need to redirect to a network node, such as a source network layer node and to perform the redirect autonomously in accordance with the embodiments of the invention.

Some examples and more detailed information regarding the exemplary embodiments of the invention are described below.

Non-limiting embodiments of the invention are targeting CSFB specific problems as similarly mentioned above. However, the exemplary embodiments of the invention can be utilized in different kinds of system change occasions other than after CSFB. For example the exemplary embodiments of the invention can be applied for the benefit of single radio voice call continuity (SRVCC), re-selection, cell selection, handover, and re-direction scenarios, to name only a few.

Referring again to FIG. 1, one possible scenario is now described. The user equipment (UE) 100 has previously undergone a CSFB and is now associated with a circuit switched RAT of the current serving network 25. In this scenario the UE 100 may be part of a call communication “B” with the network 25. It is noted that the association between the UE 100 and the network 25 can be any type of association or communication. Then in response to an end of the association or communication with the network 25, the UE 100 identifies that a re-selection from the network 25 to a source network layer is needed. In this regard the network 25 is a legacy network which does not include some or all of the updates as were described above. Therefore, the mechanisms, as are described above, are not available for the UE 100 to perform the needed re-selection.

In accordance with the exemplary embodiments, to perform the re-selection autonomously the UE 100 accesses information regarding re-selection procedures. As indicated by the signaling lines “A” and “C” this information may be communicated from the network access node(s) 10-1 and/or 10-2. The communication can be received in either or both of dedicated channel and broadcast signaling. The communication from the network access node(s) 10-1 and/or 10-2 can be created/determined using the processors 10-A1 and/or 10-A2 and initiated using the interface 10-E1 and/or 10-E2. Further, either of these network access nodes 10-1 and/or 10-2 may include the source network layer for the UE 100, or the signaling can come from another network access node other than one including the source network layer for the UE 100. In addition, the information of the re-selection procedures may be included in the system code of the UE 100, and as such previously stored in a memory such as one or more of the memories 100-B1.

In accordance with the exemplary embodiments of the invention, in view of the above described scenario, a source network layer (e.g., E-UTRAN network layer) where the CSFB had been triggered can include a network associated with either the network access nodes 10-1 and/or 10-2. This network signals to the UE 100 information including at least in part an indication, such as a message, a command, and/or an information element, as but a few examples, to inform the UE that once a connection has ended (or is about to end) that the UE is expected to autonomously return/(re)select back to source network layer, for example an E-UTRAN network layer. This information may be used by the UE after a CSFB/a re-direction/or a HO etc. in a target or currently serving cell (e.g. a GERAN/UTRAN cell etc.), after the UE has returned to IDLE in the currently serving cell, and/or after a message used to release the connection is received.

In accordance with the exemplary embodiments source system (LTE) signals can be sent and/or received prior to or during CSFB information. The signalling provides information enabling the UE to autonomously return to a source network layer or another network layer. The signaling can include an indicator to command or inform the UE to autonomously return/re-select back to source layer (E-UTRAN) once the connection with the legacy RAT is ended or is about to be ended. In addition, the information can include a neighbor cell list or neighbor information, and/or re-selection parameters which can be used by the UE in the target system to effect the autonomous re-selection. In accordance with the embodiments of the invention the information can further comprise any one or any combination of the following:

carrier/frequency/RAT/cell id/PLMN;

priority information for the above;

re-selection parameters;

parameters similar to those provided in LTE in SystemInformationBlockType 3 through SystemInformationBlockType 9 messages;

parameters provided in IdleModeMobilityControlInfo messages;

a time or timer which determines how quickly after the end of the connection in target cell UE should try to re-selection to the originating layer/or set of layers;

a time or timer which UE should wait prior initiation re-selection back to the originating layer could be determined by the specification;

alternatively the time or timer could indicate a time within which the UE needs to re-select back/return to the originating layer; and/or

alternatively the time or timer could indicate a time how long time the UE shall search the source system.

Further, as indicated above any or all of the above information could be provided for the UE in dedicated or broadcast signaling or explicitly specified in the standards.

The novel information can enable or command the UE to autonomously re-select back to the source network layer or select another non-legacy network (e.g., E-UTRAN network layer). To perform this selection the information can enable the UE to perform the selection or re-selection using any one or any combination of:

GPS-information,

time that it has been away from E-UTRAN,

previous E-UTRAN re-selections; and

UEs internal or external databases of known E-UTRAN cell locations and frequency layers.

The above described means at least enable the UE to determine how much the UE has moved during a call and/or other association with the currently serving network, and to evaluate the best candidate(s) cells for the re-selection.

In accordance with the exemplary embodiments the information can be used and/or signaled for the above described novel autonomous re-selection by the UE at least when:

the UE is camped on LTE;

the network(s) signals information to the UE that the UE needs to try return to same carrier on the source system after CS connection (attempt) has ended in the legacy system;

there is a need to establish MO/MT CS connection;

the UE sends an Extended Service Request indicating a CS call;

a CS fallback (CSFB) is performed from LTE to a legacy RAT such as GERAN

a CS call is established in the legacy RAT;

after or while a CS call is released;

a UE reads GERAN System Information-messages and notices that there is no LTE neighbor information broadcasted;

a UE evaluates the best possible cell candidate in LTE and starts an attempt to select back to the same LTE carrier where the CSFB was initiated; and

an LTE cell is found and the UE (re-)selects to that cell.

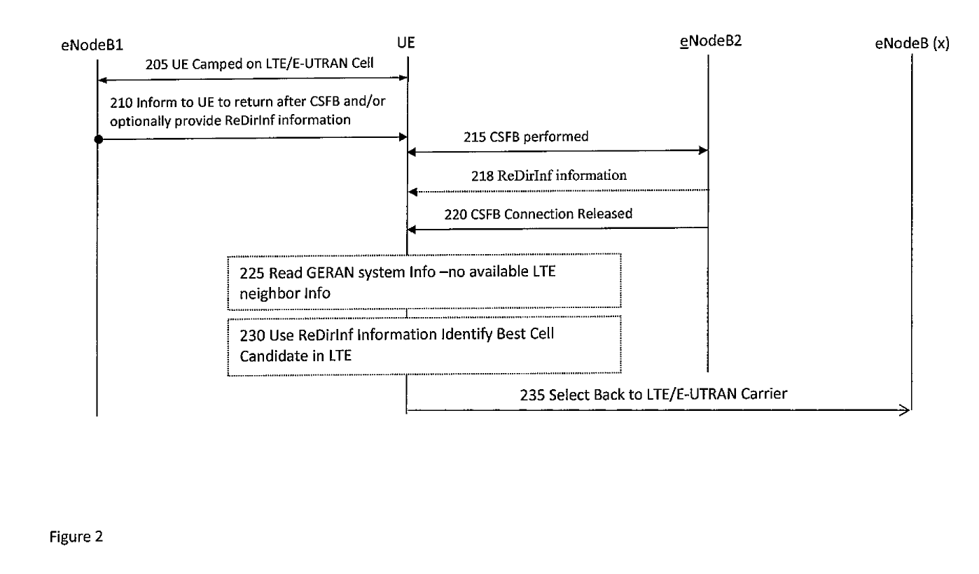

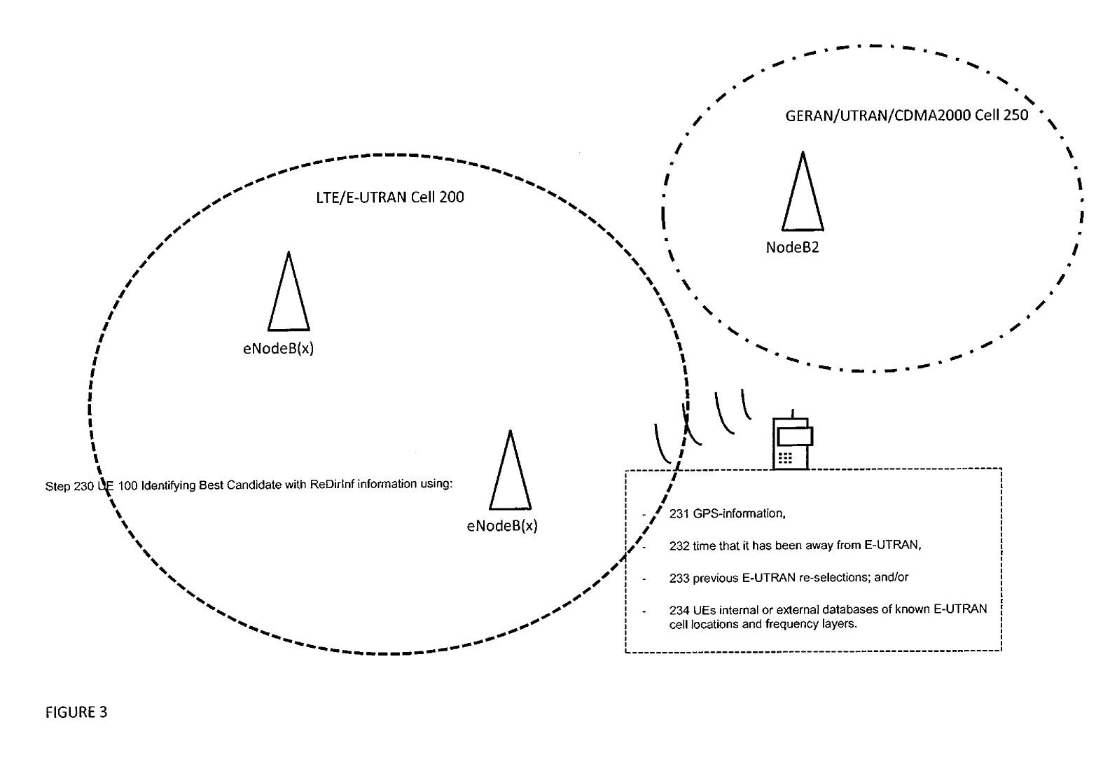

FIG. 2 illustrates a communication flow chart of a method in accordance with the exemplary embodiments of the invention. In step 205 of FIG. 2 the user equipment (UE) is camped on an LTE/E-UTRAN cell. In step 210 an eNodeB1 of the LTE/E-UTRAN carrier or cell informs the UE to return after a CSFB. In accordance with the exemplary embodiments as shown in step 210 of FIG. 2 new re-direction/re-selection information identified as ReDirInf information in FIG. 2 may optionally be provided by the eNodeB1 to the UE while the UE is camped on the eNodeB1. The term ReDirInf as used herein is non-limiting and may refer to any one(s) of network system and/or network layer change information including re-selection, selection, re-direction, re-connection, and return information. In step 215 a CSFB is performed by the UE with a NodeB2 of a legacy network cell, such as a Geran/UTRAN/CDMA2000 cell. Step 215 can further include any of the UE determining that there is a need to establish an MO CS connection, the UE sending an extending service request indicating a CS call, and a CS call is established in the Geran/UTRAN/CDMA2000 cell. Step 218 illustrates that, in accordance with the exemplary embodiments, the NodeB2 of the legacy network or a target network may provide ReDirInf information regarding a system change back to the source LTE/E-UTRAN network or network layer, or to another LTE/E-UTRAN network or network layer by the UE. If this information is provided by the NodeB2 of the legacy network, as illustrated in step 218, then the UE may use this information in combination with ReDirInf information if optionally provided by the source system eNodeB1 as in step 210. Alternatively the ReDirInf information received by the UE as in step 218 from the NodeB2 may have preference or priority over the ReDirInf information from the source system eNodeB1 as in step 210. For example, if ReDirInf information regarding a system change to the LTE/E-UTRAN network or network layer (e.g., source system) received from the legacy network (e.g., target system) is overruled by ReDirInf information from the eNodeB2 this could benefit an operator having coverage of an LTE and 3G network layer but not a GERAN network or network layer, that needs to provide CSFB and/or ReDirInf information to the UE that has roamed to the GERAN network. Or additionally when an operator has coverage for LTE and 3G as described, it may be desired that when network needs to steer the UE with CSFB to 2G, such as due to coverage reasons, that the ReDirInf provided from the LTE would override for example the system information or ReDirInf provided by the legacy network (e.g., 2G network). At step 220 the CSFB connection is released or fails for some reason. At step 225 the UE reads system information, such as broadcast information, associated with the Geran/UTRAN/CDMA2000 cell and it is identified that no LTE neighbor cell information is available in the system information. Then at step 230, in accordance with the exemplary embodiments of the invention, the UE uses the ReDirInf information and evaluates different access nodes to determine a best cell candidate in the same or another LTE/E-UTRAN cell. It is noted that this operation performed in step 230 is further detailed in FIG. 3. Then in step 235 the UE uses the identified best cell candidate, in this example eNodeB(x), to select back to an LTE/E-UTRAN carrier or cell. eNodeB(x) in the best candidate cell may be eNodeB1 or another eNodeB associated with the LTE/E-UTRAN carrier or cell. Further, in accordance with the exemplary embodiments of the invention the NodeB2 can be part of a different network layer of a same network where a eNodeB(x) is located. Further, the NodeB2 and/or the eNodeB(x) may include an access point or another type of network access node.

FIG. 3 illustrates a general cell location diagram and provides further detailed information with regards to operations performed and information used in step 230 as described above with regards to FIG. 2. As illustrated in FIG. 3, in step 230 the identifying by the UE using the ReDirInf information in accordance with the embodiments can include using any of 231 GPS-information, 232 a time that it has been away from E-UTRAN, 233 previous E-UTRAN re-selections, and/or 234 the UE's internal or external databases of known E-UTRAN cell locations and frequency layers.

Further, the above describe novel aspects of the invention of not limited to a re-selection or selection to only a source network layer by the UE. The embodiments of the invention may be used to the benefit of a UE and a system even if the NW originating the CSFB procedure would give some other target re-selection or selection layer/cell for the UE to move to.

The exemplary embodiments of the invention provide at least the advantage that a UE is enabled to autonomously return to an LTE cell even if a legacy system to which the UE is currently associated is not updated to have information of such LTE neighbor cells.

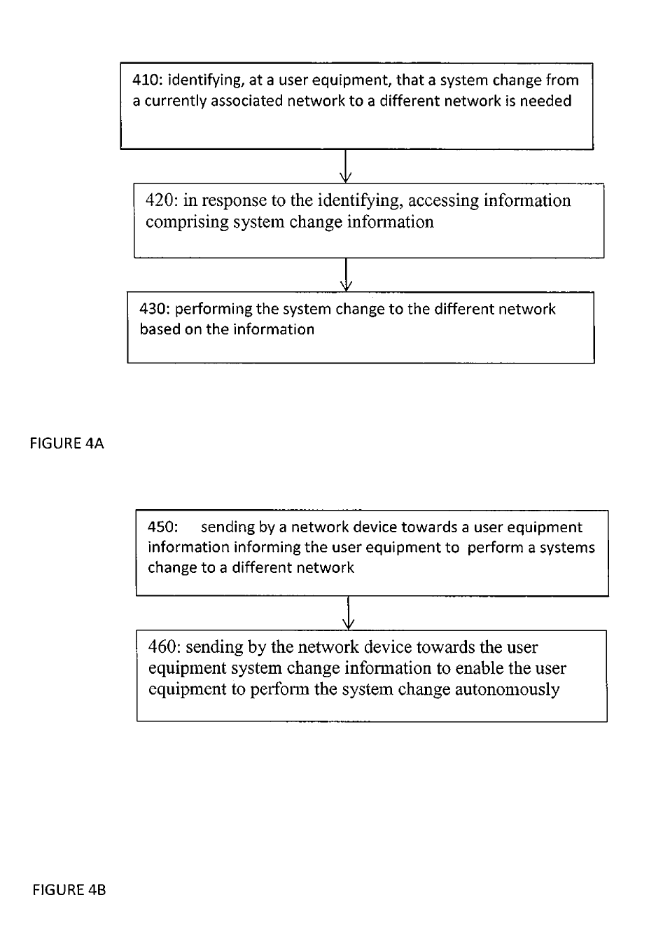

In accordance with an exemplary aspect of the invention as illustrated in FIG. 4A there is at least a method, apparatus, and executable computer program to perform actions as in step 410 of identifying at user equipment, such the user equipment 100 of FIG. 1, that a system change from a currently associated network to a different network is needed. Then as in step 420 in response to the identifying, accessing information comprising system change information. Then as in step 430 performing the system change to the different network based on the information.

In accordance with the exemplary embodiments of the invention as described in the paragraph above, the different network is a long term evolution network.

In accordance with the exemplary embodiments of the invention as described in the paragraphs above, the information is received from a long term evolution network.

In accordance with the exemplary embodiments of the invention as described in the paragraphs above, the information is received by the user equipment in a broadcast or a dedicated signaling and is received before or after the identifying that the system change is needed.

In accordance with the exemplary embodiments of the invention as described in the paragraphs above, the identifying is based on signaling received by the user equipment commanding the user equipment to perform a system change to the different network.

In accordance with the exemplary embodiments of the invention as described in the paragraphs above, the commanding is for the user equipment to perform the system change after a circuit switched communication has ended in the currently associated network.

In accordance with the exemplary embodiments of the invention as described in the paragraphs above, the currently associated network comprises one of a circuit switched radio network or a packet switched network.

In accordance with the exemplary embodiments of the invention as described in the paragraphs above, the identifying the need for the system change is after a circuit switched fallback of the user equipment to the circuit switched radio network.

In accordance with the exemplary embodiments of the invention as described in the paragraphs above, the identifying is based on at least one of a call on the currently associated network has ended or is about to end and the connection has failed or is failing.

In accordance with the exemplary embodiments of the invention as described in the paragraphs above, the different network is a source network, and where the system change information comprise procedures to utilize at least one of global positioning information, an elapsed time away from the source network, previous selections in the source network, a movement of the user equipment while in the currently associated network, or information of cell locations and frequency layers of the source network layer to perform the system change to the source network.

In accordance with the exemplary embodiments of the invention as described in the paragraphs above, the information comprises at least one of a time to wait prior to the reselecting, a time within which the reselecting is to occur, a neighbor cell list, a re-selection parameter, priority information of a carrier, a frequency of a carrier, a cell identification, information of a public land mobile network, and a length of time the user equipment should search the different network.

In accordance with the exemplary embodiments of the invention as described in the paragraphs above, the information is carried in an IdleModeMobilityControlInfo message.

In accordance with the exemplary embodiments of the invention as described in the paragraphs above, the different network is a source network for the user equipment.

In accordance with the exemplary embodiments the system change information is received from one of the different network and the currently associated network.

As in accordance with the exemplary embodiments of the invention as described in the paragraphs above, the system change information received from the different network and the currently associated network one of takes priority over system change information received from another network or is used in conjunction with system change information received from another network.

In accordance with the exemplary embodiments of the invention as described in the paragraphs above, the system change is performed autonomously by the user equipment using the system change information.

As in accordance with the exemplary embodiments of the invention as described in the paragraphs above, the system change comprises one of a cell re-selection, a cell selection, a cell reconnection, or a cell return

In addition, the exemplary embodiments of the invention as at least described and illustrated with regards to FIG. 1 can provide the means for performing at least the exemplary embodiments of the invention as described above.

In addition, in accordance with the exemplary embodiments of the invention, there is a means for identifying, at a user equipment, that a system change from a currently associated network to a different network is needed. In accordance with the exemplary embodiments there is means, in response to the identifying, for accessing information comprising system change information. Further in accordance with the exemplary embodiments there is a means for using the information the user equipment performing the system change to the different network.

The exemplary embodiments of the invention as described in the paragraph above where the means for identifying, accessing, using, and performing comprises a non-transitory memory including computer program code, and the computer program code executed by at least one processor.

In accordance with an exemplary aspect of the invention as illustrated in FIG. 4B there is at least a method, apparatus, and executable computer program to perform actions by a network device, such the network device 10-1, 10-2, and/or 10-3 of FIG. 1. In FIG. 4B there is a step 450 of sending by a network device towards a user equipment information informing the user equipment to perform a systems change to a different network. Then as in step 460 there is sending by the network device towards the user equipment system change information to enable the user equipment to perform the system change autonomously.

In accordance with the exemplary embodiments of the invention as described in the paragraphs above, the information informs the user equipment to perform the system change after a circuit switched fallback by the user equipment.

In accordance with the exemplary embodiments of the invention as described in the paragraphs above, the network device is associated with one of a different network and a currently associated network, and where the information is received from the one of the different network and the currently associated network.

In accordance with the exemplary embodiments of the invention as described in the paragraphs above, the currently associated network comprises one of a circuit switched radio network or a packet switched network.

In accordance with the exemplary embodiments of the invention as described in the paragraphs above, the system change information received from one of the different network and the currently associated network one of takes priority over system change information received from another network or is used in conjunction with system change information received from another network.

In accordance with the exemplary embodiments of the invention as described in the paragraphs above, the information comprises procedures to utilize at least one of global positioning information, an elapsed time away from the source network, previous selections in the source network, a movement of the user equipment while in the currently associated network, or information of cell locations and frequency layers of the source network layer to enable the user equipment to perform the system change autonomously.

In accordance with the exemplary embodiments of the invention as described in the paragraphs above, the system change comprises one of a cell re-selection, a cell selection, a cell reconnection, or a cell return.

In accordance with the exemplary embodiments of the invention there is means for sending by a network device towards a user equipment information informing the user equipment to perform a systems change to a different network; and means for sending by the network device towards the user equipment system change information to enable the user equipment to perform the system change autonomously.

In accordance with the exemplary embodiments of the invention as described in the paragraph above, the means for sending comprises a network interface, and a non-transitory memory including computer program code, and the computer program code executed by at least one processor.

In general, the various embodiments of the user equipment (e.g., mobile station, device, terminal, etc.) 100 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

In accordance with an exemplary aspect of the invention as illustrated in FIG. 4A there is at least a method, apparatus, and executable computer program to perform actions as in step 410 . . . .

The embodiments of this invention may be implemented by computer software executable by a data processor of the User Equipment 100, such as the processor 100-A1, or by hardware, or by a combination of software and hardware. Further in this regard it should be noted that the various blocks of the logic flow diagram of FIGS. 2A and 2B may represent program steps, or interconnected logic circuits, blocks and functions, or a combination of program steps and logic circuits, blocks and functions. It is noted that any of these devices may have multiple processors (e.g. RF, baseband, imaging, user interface) which operate in a slave relation to a master processor. The teachings may be implemented in any single one or combination of those multiple processors.

The memory [or memories] 100-B1, 10-B1, 10-B2, and/or 10-B3 may be of any type suitable to the local technical environment and may be implemented using any suitable data storage technology, such as semiconductor-based memory devices, magnetic memory devices and systems, optical memory devices and systems, fixed memory and removable memory. The data pro cessor[s] 100-G1, 100-A1, 10-A1, 10-G1, 10-A2, 10-G2, 10-A3, and/or 10-G3 may be of any type suitable to the local technical environment, and may include one or more of general purpose computers, special purpose computers, microprocessors, digital signal processors (DSPs) and processors based on a multi-core processor architecture, as non-limiting examples.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the preferred embodiments of this invention could be used to advantage without the corresponding use of other features. As such, the foregoing description should be considered as merely illustrative of the principles of the invention, and not in limitation thereof.

1-46. (canceled)

47. An apparatus comprising:
at least one processor; and
at least one memory including computer program code, where the at least one memory and the computer program code are configured, with the at least one processor, to cause the apparatus to at least:
identify, at a user equipment, that a system change from a currently associated network to a different network is needed;
in response to the identifying, access information comprising system change information; and
perform the system change to the different network based on the information,
where the identifying is based on signaling received by the user equipment commanding the user equipment to perform a system change to the different network.

48. The apparatus according to claim 47, where the information is received from a long term evolution network.

49. The apparatus according to claim 47, where the information is received by the user equipment in a broadcast or a dedicated signaling and is received before or after the identifying that the system change is needed.

50. The apparatus according to claim 47, where the commanding is for the user equipment to perform the system change after a circuit switched communication has ended in the currently associated network.

51. The apparatus according to claim 47, where the currently associated network comprises one of a circuit switched radio network or a packet switched network.

52. The apparatus according to claim 51, where the identifying the need for the system change is after a circuit switched fallback of the user equipment to the circuit switched radio network.

53. The apparatus according to claim 47, where the identifying is based on at least one of a call on the currently associated network has ended or is about to end and the connection has failed or is failing.

54. The apparatus according to claim 47, where the different network is a source network, and where the system change information comprise procedures to utilize at least one of global positioning information, an elapsed time away from the source network, previous selections in the source network, a movement of the user equipment while in the currently associated network, or information of cell locations and frequency layers of the source network layer to perform the system change to the source network.

55. The apparatus according to claim 47, where the information comprises at least one of a time to wait prior to the reselecting, a time within which the reselecting is to occur, a neighbor cell list, a re-selection parameter, priority information of a carrier, a frequency of a carrier, a cell identification, information of a public land mobile network, and a length of time the user equipment should search the different network.

56. The apparatus according to claim 55, where the information is carried in an IdleModeMobilityControlInfo message.

57. The apparatus according to claim 47, where the different network is a source network for the user equipment.

58. The apparatus according to claim 47, where the system change information is received from one of the different network and the currently associated network, and where the system change comprises one of a cell re-selection, a cell selection, a cell reconnection, or a cell return.

59. The apparatus according to claim 58, where the system change information received from the one of the different network and the currently associated network takes priority over system change information received from another network or is used in conjunction with system change information received from another network.

60. An apparatus comprising:
at least one processor; and
at least one memory including computer program code, where the at least one memory and the computer program code are configured, with the at least one processor, to cause the apparatus to at least:
send towards a user equipment information informing the user equipment to perform a systems change to a different network; and
send towards the user equipment system change information to enable the user equipment to perform the system change autonomously.

61. The apparatus according to claim 60, where the information informs the user equipment to perform the system change after a circuit switched fallback by the user equipment.

62. The apparatus according to claim 60, where network device is associated with one of a different network and a currently associated network, and where the information is received from the one of the different network and the currently associated network.

63. The apparatus according to claim 60, where the system change information received from one of the different network and the currently associated network one of takes priority over system change information received from another network or is used in conjunction with system change information received from another network.

64. The apparatus according to claim 60, where the information comprises procedures to utilize at least one of global positioning information, an elapsed time away from the source network, previous selections in the source network, a movement of the user equipment while in the currently associated network, or information of cell locations and frequency layers of the source network layer to enable the user equipment to perform the system change autonomously.

65. A method comprising:
identifying, at a user equipment, that a system change from a currently associated network to a different network is needed;
in response to the identifying, accessing information comprising system change information; and
performing the system change to the different network based on the information,
where the identifying is based on signaling received by the user equipment commanding the user equipment to perform a system change to the different network.

66. The method according to claim 65, where the commanding is for the user equipment to perform the system change after a circuit switched communication has ended in the currently associated network.
